(19) United States
(12) Patent Application Publication
(10) Pub. No.: US 2018/0115935 A1
(43) Pub. Date: Apr. 26, 2018

(54) CELLULAR NETWORK ASSISTED WLAN DISCOVERY AND SELECTION

(71) Applicant: T-Mobile USA, Inc., Bellevue, WA (US)

(72) Inventors: Yousif Targali, Sammamish, WA (US); Omar Hassan, Kirkland, WA (US); Samir M. Hodroj, Bothell, WA (US)

(21) Appl. No.: 15/299,090

(22) Filed: Oct. 20, 2016

(51) Int. Cl. H04W 36/22; H04W 36/14

(52) U.S. Cl. CPC H04W 36/22; H04W 88/06; H04W 36/14

(57) ABSTRACT

The systems, devices, and methods discussed herein are directed to a portable communication device, or a user equipment (UE), for discovering and accessing services through a wireless local area network (WLAN) that has not previously been provisioned for the UE without having a user of the UE provide credential information. To access services through an unprovisioned WLAN, the UE sends a request to its mobile network operator (MNO), and causes the MNO to request to, and receive from, the WLAN service provider the credential information for the UE, which is used to provision both the WLAN and UE.

### BACKGROUND

Modern telecommunication systems include heterogeneous mixtures of second, third, and fourth generation (2G, 3G, and 4G) cellular-wireless access technologies, which can be cross-compatible and can operate collectively to provide data communication services. Global Systems for Mobile (GSM) is an example of 2G telecommunications technologies; Universal Mobile Telecommunications System (UMTS) is an example of 3G telecommunications technologies; and Long Term Evolution (LTE), including LTE Advanced, and Evolved High-Speed Packet Access (HSPA+) are examples of 4G telecommunications technologies.

In addition, a new generation of portable communication devices, or user equipment (UE), are capable of making phone calls over a wireless local area network (WLAN) such as Wi-Fi™ Hotspots. To use Wi-Fi services from Hotspot service operators, it requires a Wi-Fi call capable UE to be provisioned with credentials to gain access to a Hotspot network. If the UE is not provisioned, the user may be required to go through the process of online signup for setting up a new account with the hotspot service provider. The online signup may require the user to provide sensitive information such as the user's name, billing address, social security number, credit card information, etc. with a Hotspot service provider. This process may be acceptable for the user registering on a trusted and/or well-known Hotspot network, however, the user may be reluctant to share such sensitive information with an unknown hotspot service provider.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items or features.

FIG. 1 illustrates an example environment in which a portable communication device, or user equipment (UE), accesses services via a wireless local area network (WLAN) in accordance with at least one aspect of the present disclosure.

FIG. 2 illustrates an example process for the UE to access services through the WLAN in accordance with at least one aspect of the present disclosure.

FIG. 3 illustrates an example process detailing one of the blocks of FIG. 2 in accordance with at least one aspect of the present disclosure.

FIG. 4 illustrates an example process detailing another one of the blocks of FIG. 2 in accordance with at least one aspect of the present disclosure.

FIG. 5 illustrates an example process detailing yet another one of the blocks of FIG. 2 in accordance with at least one aspect of the present disclosure.

FIG. 6 illustrates an example block diagram of the UE in accordance with at least one aspect of the present disclosure.

FIG. 7 illustrates an example sequence diagram for the UE to access services through the WLAN in accordance with at least one aspect of the present disclosure.

FIG. 8 illustrates an example process for a mobile network operator to provide the UE access to services through an unassociated WLAN in accordance with at least one aspect of the present disclosure.

### DETAILED DESCRIPTION

The systems, devices, and methods discussed herein are directed to a portable communication device, or a user equipment (UE), for discovering and accessing services through a wireless local area network (WLAN) that has not previously been provisioned for the UE without having a user of the UE provide credential information. To access services through a WLAN, a Wi-Fi call capable UE must be provisioned with credentials from a WLAN service provider of the WLAN to gain access to the WLAN. If the UE is not provisioned, the user may be able to go through the online signup (OSU) process to create a new account with the WLAN service provider, however, the user may be required to provide sensitive information such as his/her name, billing address, social security number, credit card information, etc. Instead of having the user provide potentially sensitive information to an unknown, or a previously unassociated, WLAN service provider, the present disclosure provides systems, devices, and methods that leverage a trust relationship between the user and the cellular network operator of the UE.

As the UE scans and discovers WLANs that are unprovisioned or untrusted for the UE, it determines which of the WLANs may be available to provide services. The UE may select WLANs based on desired criteria such as signal strength, quality of service (QoS), data rate, bandwidth, security, and the like. The UE then establishes communication with its mobile network operator (MNO) via cellular network, and send a request for access to the selected WLAN, or WLANs. The MNO then sends a request to the WLAN service provider of the selected WLAN for a WLAN service for the UE. In return, the WLAN service provider send a response including access credentials to the MNO, and also provisions the selected WLAN with the access credentials for the UE. The UE downloads from the MNO a profile including the access credentials that the WLAN service provider sent to the MNO, and registers with the selected WLAN to access services through the selected WLAN.

The systems, devices, and methods described herein can be implemented in a number of ways. Example implementations are provided below with reference to the following figures.

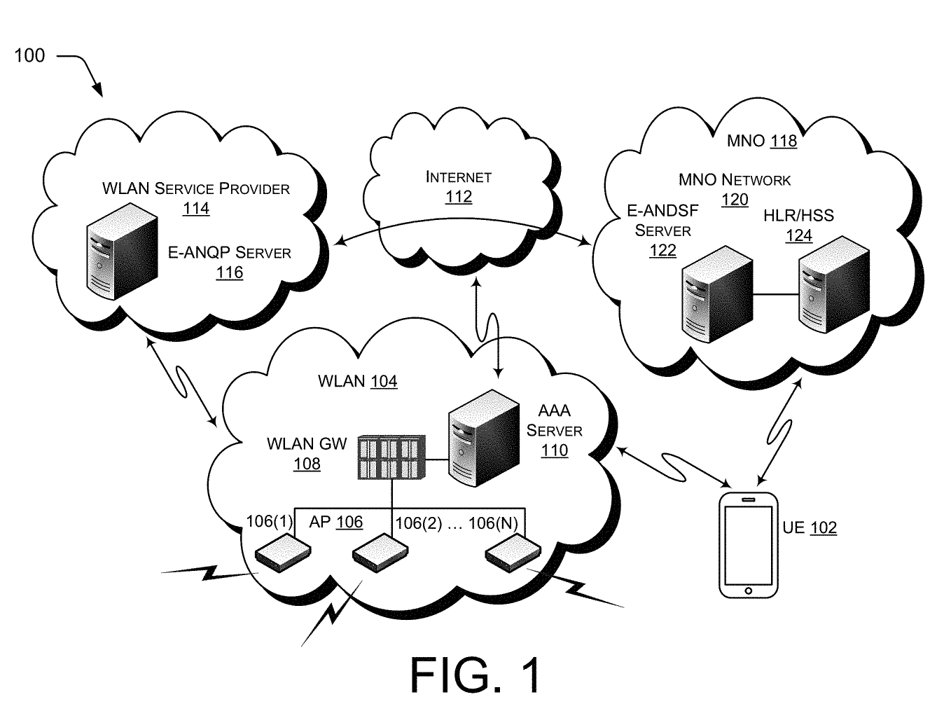

FIG. 1 illustrates an example environment 100 in which a portable communication device, or user equipment (UE), 102 accesses services via a wireless local area network (WLAN) 104 in accordance with at least one aspect of the present disclosure.

The WLAN 104 comprises N access points (AP) 106 of which three (106(1), 106(2), and 106(N)) are shown, a WLAN gateway (GW) 108 communicatively coupled to the AP 106, and an authentication, authorization, accounting (AAA) server 110 communicatively coupled to the WLAN GW 108. The AP 106 is a transceiver that connects a WLAN device, such as the UE 102, to the WLAN. The WLAN GW 108 routes data packets from the AP 106 to other network and vice versa. The AAA server 110 tracks user activities by authenticating the user with unique identifying information, authorizing the user to access the network and services, and accounting, or tracking, the activities of the user. The AAA server 110 may be connected other servers via Internet 112. The WLAN 104 is communicatively coupled to a WLAN service provider 114 which provides services accessible through APs 106 to devices registered with the WLAN 104. The WLAN service provider 114 comprises an enhanced access network quality protocol (E-ANQP) server 116, which WLAN devices, such as the UE 102, use to perform network discovery. The UE 102 is capable of establishing communication with a wireless local area network such as the WLAN 104 and with a cellular network which may be a network of a mobile network operator (MNO) 118 of the UE 102, MNO network 120. The MNO network 120 comprises an enhanced access network discovery and selection function (E-ANDSF) server 122 and a home location register/home subscriber server (HLR/HSS) 124. The E-ANDSF server 122 assists the UE 102 in discovering WLANs and provides the UE 102 with rules and policies for connecting to the WLANs. The HLR/HSS 124 stores and updates the user subscription information, and also generates security information.

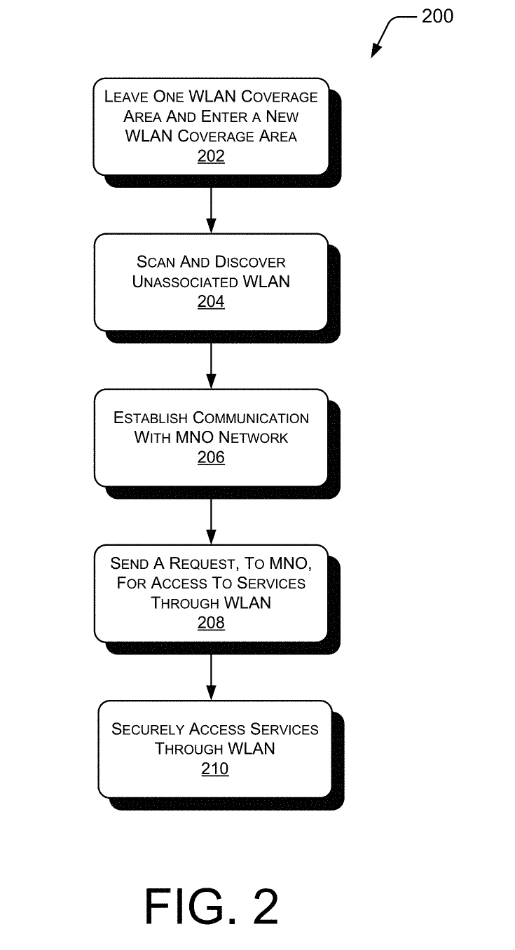

FIG. 2 illustrates an example process 200 for the UE 102 to access services through the WLAN 104 in accordance with at least one aspect of the present disclosure. As the user, or more specifically the UE 102, leaves one WLAN coverage area and enters a new WLAN coverage area in block 202, the UE 102 scans to discover an available WLAN, which may be unassociated with the UE 102, in the new area in block 204. Upon discovering the WLAN 104 that is available and unassociated, the UE 102 establishes communication with the MNO network 120 in block 206, and sends a request, to the MNO 118, for access to services through the unassociated WLAN 104 in block 208. Then the UE 102, in block 210, securely accesses the services through the unassociated WLAN 104.

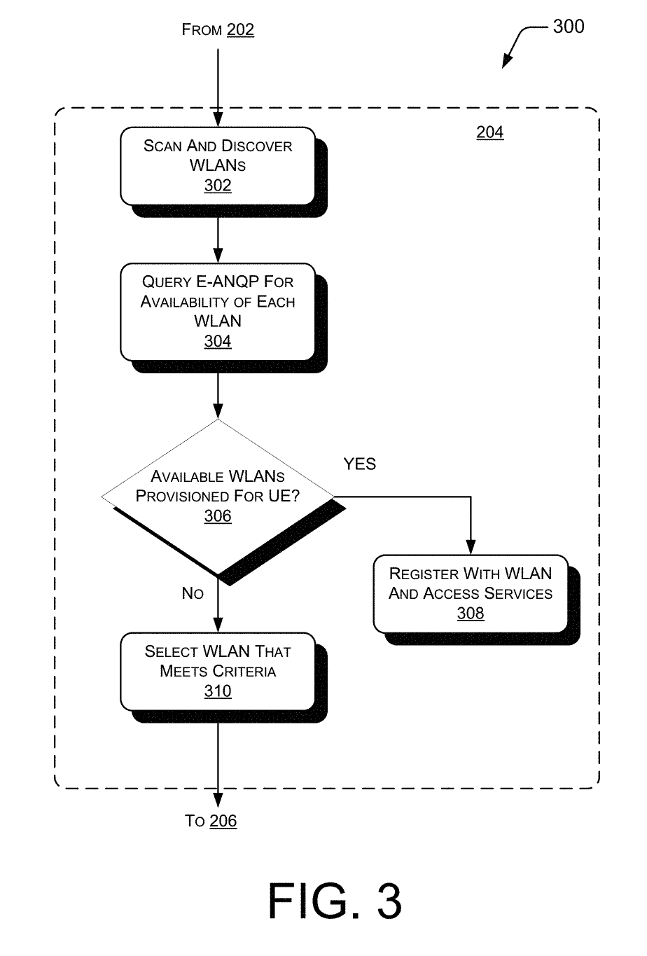

FIG. 3 illustrates an example process 300 detailing block 204 in accordance with at least one aspect of the present disclosure. In block 302, as the UE 102 scans for WLANs, it may discover multiple WLANs, each of which may be supported by a separate WLAN service provider with its own E-ANQP server. In block 304, the UE102 queries each E-ANQP server of the discovered WLANs to determine availability of each WLAN, and determines if the discovered WLANs included a WLAN already provisioned to work with the UE 102 in block 306. If a provisioned WLAN is identified, then the UE 102 registers with the provisioned WLAN and begins accessing services through the provisioned WLAN in block 308. However, if no provisioned WLAN is identified, then the UE 102 may select a particular WLAN, i.e. the unassociated WLAN 104, which meets predetermined criteria in block 310. The predetermined criteria may include, but not limited to, signal strength, quality of service, available bandwidth, available bit rate, security, and the like.

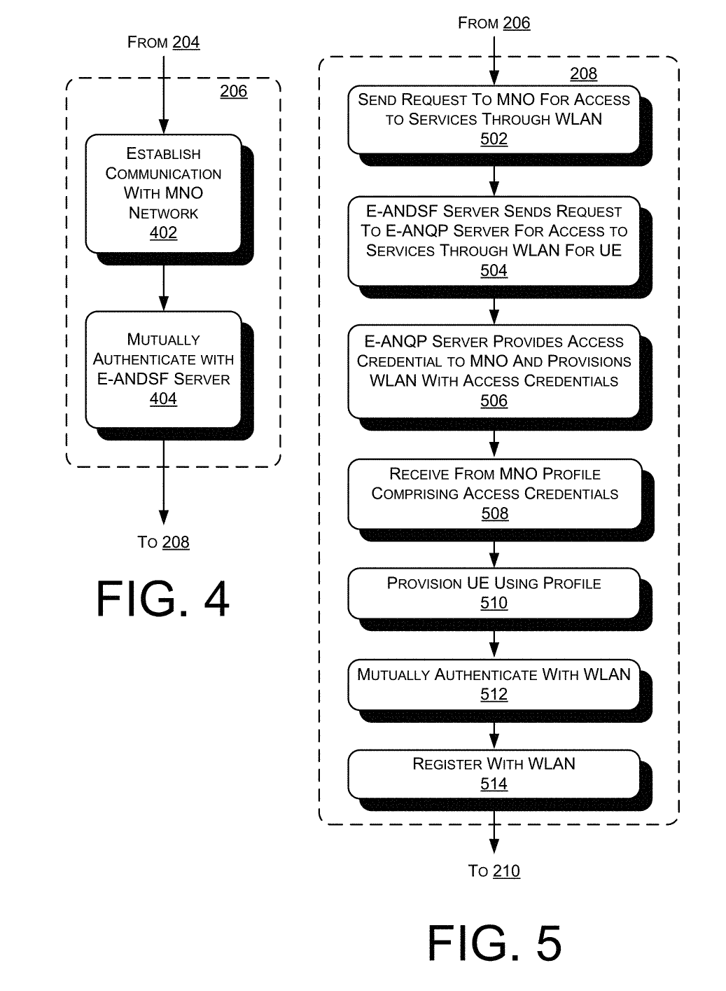

FIG. 4 illustrates an example process detailing block 206 in accordance with at least one aspect of the present disclosure. Once the UE 102 selects the unassociated WLAN 104, which is not yet provisioned to provide secure access to the UE 102, the UE 102 establishes communication with the MNO network 120 in block 402. The UE 102 then mutually authenticates with the E-ANDSF server 122 of the MNO 118 in block 404. Once authenticated, the UE 102 sends a request, to the E-ANDSF server 122 of the MNO 118, for access to services through the WLAN 104 in block 208.

FIG. 5 illustrates an example process detailing block 208 in accordance with at least one aspect of the present disclosure. In response to the request from the UE 102 for access to services through the selected WLAN, the unassociated WLAN 104, in block 502, the MNO 118 performs, or the UE 102 causes the MNO 118 to perform, the following steps. In block 504, the E-ANDSF server 122 of the MNO 118 sends a request, to the E-ANQP server 116 of the WLAN service provider 114, for access to the services through the WLAN 104 for the UE 102. The E-ANDSF server 122 may also check for online-sign-up (OSU) availability for the WALN 104, and receive it if available. In response to the request, in block 506, the E-ANQP server 116 of the WLAN service provider 114 provides, or the MNO 118 causes the E-ANQP server 116 of the WLAN service provider 114 to provide, access credentials required for the UE 102 to access services through the unassociated WLAN 104. The E-ANQP server 116 also provisions, or the MNO 118 causes the E-ANQP server 116 to provision, the WLAN unassociated 104 with the access credentials. In block 508, the UE 102 receives from the E-ANDSF 122 a profile comprising the access credentials. The UE 102 provisions itself using the profile in block 510, and mutually associate and authenticate with the WLAN 104 using the profile and the access credentials of the unassociated WLAN 104 in block 512. In block 514, the UE 102 registers with the unassociated WLAN 104. During this process, if the UE 102 found more than one WLAN satisfying all of the steps above, the UE 102 may register with more than one WLANs, and may simultaneously access services through these WLANs.

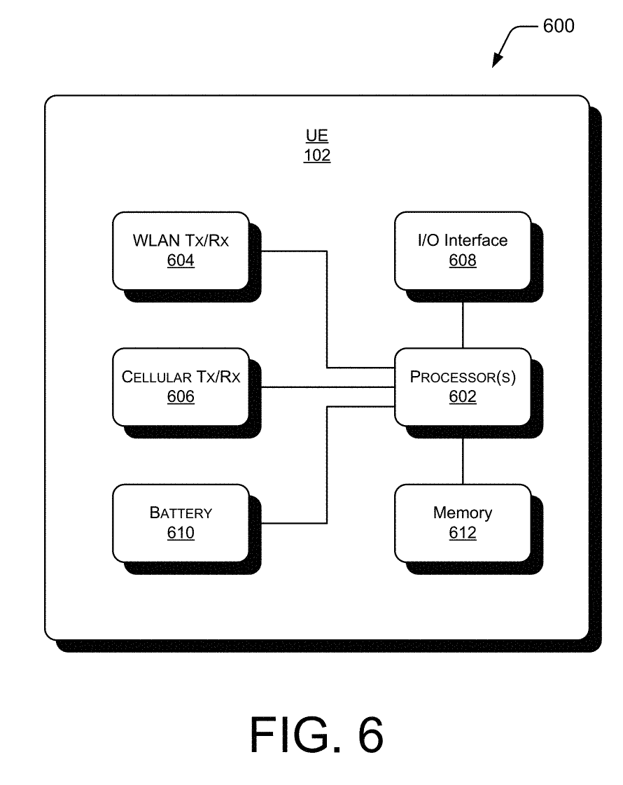

FIG. 6 illustrates an example block diagram 600 of the UE 102 in accordance with at least one aspect of the present disclosure. The UE comprises one or more processors 602, a WLAN transceiver 604, and a cellular transceiver 606. Both transceivers 604 and 606 are communicatively coupled to the one or more processors 602, and may be directly or indirectly coupled to other components and/or modules of the UE 102. In some embodiments, the one or more processors 602 may be a central processing unit (CPU), a graphics processing unit (GPU), or both CPU and GPU, or other processing unit or component known in the art. The WLAN transceiver 604 is configured to establish communication between the UE 102 and a WLAN, such as the unassociated WLAN 104 described above, using a WLAN specific communication method such as a 802.11 family of standards and the like. The cellular transceiver 606 is configured to establish communication between the UE 102 and a cellular network, such as the MNO network 120 described above, using a cellular network specific communication method such as the 3G, 4G, LTE and the like.

The UE 102 further comprises an input/output (I/O) interface 608, a battery 610, and memory 612, each communicable coupled the one or more processors 602 and may be directly or indirectly coupled to other components and/or modules of the UE 102. The I/O interface 608 may include a keyboard, mouse, touch pad, touch screen, microphone, and the like, configured to receive an input from a user and may also include a speaker, display which may be a touchscreen, and the like, configured to provide an output for the user. The battery 610 provides power to all components and modules of the UE 102 requiring power. Memory 612 may include volatile memory (such as random access memory (RAM)) and/or non-volatile memory (such as read-only memory (ROM), flash memory, etc.). Memory 612 may also include additional removable storage and/or non-removable storage including, but not limited to, flash memory, magnetic storage, optical storage, and/or tape storage that may provide non-volatile storage of computer-readable instructions, data structures, program modules, and other data for the UE 102.

Memory 612 is an example of computer-readable media. Computer-readable media includes at least two types of computer-readable media, namely computer storage media and communications media. Computer storage media includes volatile and non-volatile, removable and non-removable media implemented in any process or technology for storage of information such as computer-readable instructions, data structures, program modules, or other data. Computer storage media includes, but is not limited to, phase change memory (PRAM), static random-access memory (SRAM), dynamic random-access memory (DRAM), other types of random-access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transmission medium that can be used to store information for access by a computing device. In contrast, communication media may embody computer-readable instructions, data structures, program modules, or other data in a modulated data signal, such as a carrier wave, or other transmission mechanism. As defined herein, computer storage media does not include communication media.

The computer-executable instructions stored on one or more computer-readable storage media that, when executed by one or more processors, perform operations described above with reference to FIGS. 2-5. Generally, computer-executable instructions include routines, programs, objects, components, data structures, and the like that perform particular functions or implement particular abstract data types. The order in which the operations are described is not intended to be construed as a limitation, and any number of the described operations can be combined in any order and/or in parallel to implement the processes.

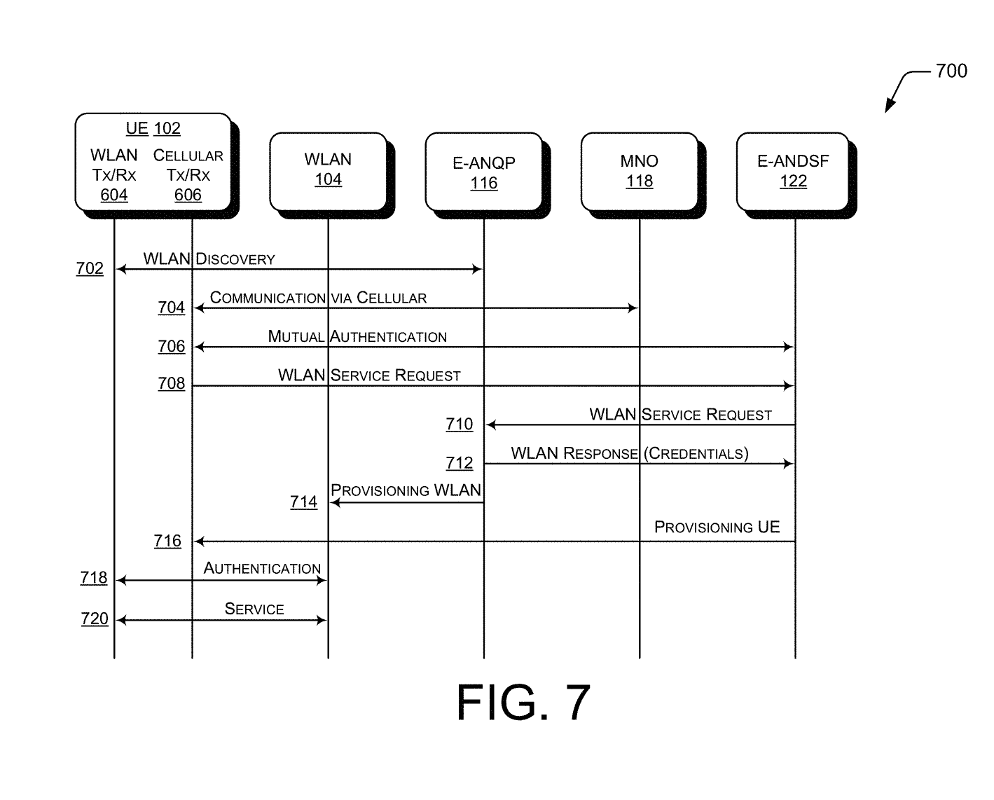

FIG. 7 illustrates an example sequence diagram 700 for the UE 102 to access services through the unassociated WLAN 104 in accordance with at least one aspect of the present disclosure. The UE 102 comprises the WLAN transceiver 604 and the cellular transceiver 606 as described above with reference to the UE 102 in FIG. 6. As described above with reference to block 204 of FIG. 3, at 702, the WLAN transceiver 604 scans and discovers an associated WLAN, i.e. the unassociated WLAN 104, by querying the E-ANQP server 116. If the WLAN transceiver 604 discovered multiple WLANs, each of which supported by a separate WLAN service provider with its own E-ANQP server, then each E-ANQP server of the discovered WLANs might be queried to determine availability of each WLAN. If a provisioned WLAN is identified, then the UE 102 registers with the provisioned WLAN and begins accessing services through the provisioned WLAN. However, if no provisioned WLAN is identified, then the UE 102 may select a particular WLAN, i.e. the unassociated WLAN 104, based on predetermined criteria, which may include but not limited to signal strength, quality of service, available bandwidth, available bit rate, security, and the like.

Once the UE 102 selects the unassociated WLAN 104, which is not yet provisioned to provide secure access to the UE 102, the UE 102, through the cellular transceiver 606, establishes communication with the MNO network 120 at 704. Through the cellular transceiver 606, the UE 102 mutually authenticates with the E-ANDSF server 122 of the MNO 118 at 706. Once authenticated, the UE 102 sends a request to the E-ANDSF server 122 of MNO 118, using the cellular transceiver 606, for access to services through the WLAN 104 at 708.

The E-ANDSF server 122, in response to the request, sends another request to the E-ANQP server 122 for access to the services through the WLAN 104 for the UE 102 at 710. The E-ANDSF server 122 may also check for online-sign-up (OSU) availability for the unassociated WLAN 104, and receive it if available. At 712, in response to the request, the E-ANQP server 122 of the WLAN service provider 114 provides, or the MNO 118 causes the E-ANQP server 122 of the WLAN service provider 114 to provide, access credentials required for the UE 102 to access services through the unassociated WLAN 104. The E-ANQP server 116 also provisions, or the MNO 118 causes the E-ANQP server 116 to provision, the unassociated WLAN 104 with the access credentials at 714. At 716, the UE 102 receives from the E-ANDFS server 122, via the cellular transceiver 606, a profile comprising the access credentials, and provisions itself using the profile. At 718, the UE 102 mutually associate and authenticate with the unassociated WLAN 104 using the profile and the access credentials of the unassociated WLAN 104. The UE 102 begins to securely access services through the unassociated WALN 104 at 720 via the WALN transceiver 604.

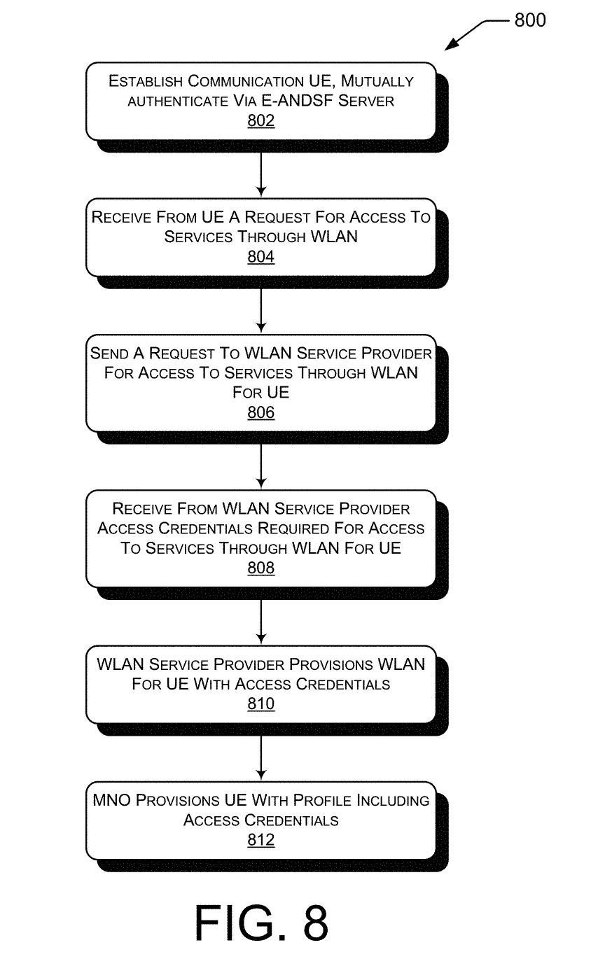

FIG. 8 illustrates an example process 800 for the MNO 118 to provide the UE 102 access to services through the unassociated WLAN 104 in accordance with at least one aspect of the present disclosure. In 802, the MNO establishes communication with the UE 102, and mutually authenticates via the E-ANDSF sever 122 of the MNO 118 as described above with reference to block 206 in FIG. 4. In 804, the MNO 118 receives from the UE 102 a request for access to services through the unassociated WLAN 104. As described above with reference to block 204 in FIG. 3, the UE 102 scans for WLANs and queries an E-ANQP server of discovered WLANs, and selects a WLAN, such as the WLAN 104, that is available but currently unassociated with the UE 102. The request from the UE 102 may include a WLAN access profile for the unassociated WLAN 104 received from the E-ANQP server 116 of the WLAN service provider 114. In response to the request from the UE 102, in block 806, the MNO 118 sends a request to the WLAN service provider 114 of the unassociated WLAN 104 for access to services through the WLAN 104 for the UE 102.

In response to sending the request to the WLAN service provider 114, the MNO 118 receives access credentials required for the portable communication device to access the services through the WLAN in block 808. The WLAN service provider 114 provisions, or the MNO 118 causes the WLAN service provider 114 to provision, the unassociated WLAN 104 with the access credentials in block 810. The MNO 118 then provisioning the UE 102 with a profile comprising the access credentials by downloading the profile to the UE 102.

### CONCLUSION

Although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claims.

What is claimed is:

1. A method in a portable communication device comprising:
discovering a unassociated wireless local area network (WLAN);
upon discovering the unassociated WLAN, establishing communication with a cellular network;
sending a request, to the cellular network, for access to services through the unassociated WLAN; and
accessing the services through the unassociated WLAN.

2. A method of claim 1, wherein discovering the unassociated WLAN comprises:
querying an enhanced access network quality protocol (E-ANQP) server of the unassociated WLAN to determine availability of the unassociated WLAN.

3. A method of claim 2, further comprising;
receiving an access profile for the unassociated WLAN.

4. A method of claim 2, wherein establishing communication with the cellular network comprises:
establishing communication with a mobile network operator of the portable communication device; and
mutually authenticating the portable communication device and an enhanced access network discovery and selection function (E-ANDSF) server associated with the mobile network operator with each other.

5. A method of claim 4, further comprising:
causing the mobile network operator to:
send, to a WLAN service provider of the unassociated WLAN, another request for access to the services through the unassociated WLAN for the portable communication device;
cause the WLAN service provider to:
provide, to the mobile network operator, access credentials required for the portable communication device to access the services through the unassociated WLAN, and
provision the unassociated WLAN with the access credentials.

6. A method of claim 5, further comprising:
receiving, from the mobile network operator, a profile comprising the access credentials;
provisioning the portable communication device using the profile; and
registering the portable communication device with the unassociated WLAN.

7. A method of claim 6, wherein registering the portable communication device with the unassociated WLAN comprises:
mutually authenticating the portable communication device and the unassociated WLAN using the profile and the access credentials.

8. A method of claim 1, wherein discovering the unassociated WLAN comprises:
identifying a plurality of WLANs;
querying an enhanced access network quality protocol (E-ANQP) server of each of the identified WLANs to determine availability of each WLAN; and
selecting the unassociated WLAN from the identified WLANs based upon predetermined criteria.

9. A portable communication device comprising:
one or more processors;
a wireless local area network (WLAN) transceiver communicatively coupled to the one or more processors, the WLAN transceiver configured to communicate with a WLAN;
a cellular network transceiver communicatively coupled to the one or more processors, the cellular network transceiver configured to communicate with a cellular network;
memory communicatively coupled to the one or more processors, the memory storing instructions and executable by the one or more processors to perform operations comprising:
discovering, by the WLAN transceiver, an unassociated WLAN;
upon discovering the unassociated WLAN, establishing, by the cellular transceiver, communication with a cellular network;
sending, by the cellular transceiver to the cellular network, a request for access to services through the unassociated WLAN; and
accessing, by the unassociated WLAN transceiver, the services through the WLAN.

10. A portable communication device of claim 9, wherein the operation of discovering, by the WLAN transceiver, the unassociated WLAN comprises:
querying an enhanced access network quality protocol (E-ANQP) server of the unassociated WLAN to determine availability of the unassociated WLAN.

11. A portable communication device of claim 9, wherein the operation of discovering, by the WLAN transceiver, the unassociated WLAN further comprises:
receiving an access profile for the unassociated WLAN.

12. A portable communication device of claim 11, wherein the operation of establishing, by the cellular transceiver, communication with the cellular network comprises:
establishing communication with a mobile network operator of the portable communication device; and
mutually authenticating the portable communication device and an enhanced access network discovery and selection function (E-ANDSF) server associated with the mobile network operator with each other.

13. A portable communication device of claim 12, wherein the operation of sending the request, by the cellular transceiver to the cellular network, for access to the services through the unassociated WLAN comprises:
causing the cellular network to:
send, to a WLAN service provider of the unassociated WLAN, another request for access to the services through the unassociated WLAN for the portable communication device;
receive, from the WLAN service provider, access credentials required for the portable communication device to access the services through the unassociated WLAN; and
cause the WLAN service provider to provision the WLAN with the access credentials.

14. A portable communication device of claim 13, wherein the operation of sending the request, by the cellular transceiver to the cellular network, for access to the services through the unassociated WLAN further comprising:
receiving, from the cellular network, a profile comprising the access credentials;
provisioning the portable communication device using the profile; and
registering the portable communication device with the unassociated WLAN.

15. A portable communication device of claim 14, wherein the operation of sending the request, by the cellular transceiver to the cellular network, for access to the services through the unassociated WLAN further comprising:
mutually authenticating the portable communication device and the unassociated WLAN using the profile and the access credentials.

16. A portable communication device of claim 9, wherein the operation of discovering, by the WLAN transceiver, the unassociated WLAN comprises:
identifying a plurality of WLANs;
querying an enhanced access network quality protocol (E-ANQP) server of each of the identified WLANs to determine availability of each WLAN; and
selecting the unassociated WLAN from the identified WLANs based upon predetermined criteria.

17. A method for a mobile network operator to provide access to services through an unassociated wireless local area network (WLAN) for a portable communication device, the method comprising:
receiving, from the portable communication device, a request for access to services through an unassociated WLAN discovered by the portable communication device;
sending another request to a WLAN service provider of the unassociated WLAN for access to services through the unassociated WLAN for the portable communication device;
in response to sending the other request, receiving from the WLAN service provider access credentials required for the portable communication device to access the services through the unassociated WLAN;
causing the WLAN service provider to provision the unassociated WLAN with the access credentials; and
provisioning the portable communication device with a profile comprising the access credentials.

18. A method of claim 17, further comprising:
prior to receiving the request from the portable communication device, mutually authenticating with the portable communication device via an enhanced access network and discovery selection (E-ANDSF) server of the mobile network operator.

19. A method of claim 18, wherein receiving, from the portable communication device, the request for access to services through the unassociated WLAN comprises:
receiving an access profile for the unassociated WLAN.

20. A method of claim 17, wherein provisioning the portable communication device comprises:
downloading the profile comprising the access credentials to the portable communication device.
